(19) United States
(12) Patent Application Publication
(10) Pub. No.: US 2012/0181059 A1
(43) Pub. Date: Jul. 19, 2012

(54) HIGH VOLTAGE CABLE DESIGN FOR ELECTRIC AND HYBRID ELECTRIC VEHICLES

(76) Inventors: J. Axel Radermacher, Foothill Ranch, CA (US); Andrew Shune, San Clemente, CA (US)

(21) Appl. No.: 13/386,670

(22) PCT Filed: Jul. 26, 2010
(86) PCT No.: PCT/US2010/043214

§ 371 Date: Apr. 9, 2012

Related U.S. Application Data
(60) Provisional application No. 61/228,191, filed on Jul. 24, 2009.

(51) Int. Cl. H01B 9/04

(52) U.S. Cl. 174/115; 174/113 R

(57) ABSTRACT

A coaxial cable capable of transmitting high load electrical power, such as three phase electrical power, or a single phase high voltage DC, while minimizing the amount of electromagnetic noise emitted from the cable. The coaxial cable consists of at least three conducting layers with each conducting layer surrounded by an insulation layer. Additionally the disclosure relates to a coaxial cable with two conducting layers used for DC power transmission.

### CROSS REFERENCE TO RELATED APPLICATIONS

This application claims the benefit of and priority to U.S. Provisional Application No. 61/228,191, filed Jul. 24, 2009, which is incorporated herein by reference.

### BACKGROUND

The present disclosure relates generally to a cable, and more particularly to a multiphase high power coaxial cable.

### DESCRIPTION OF THE RELATED ART

A coaxial cable is a common type of electrical cable. As shown in an example of a prior art coaxial cable shown in FIG. 7, a coaxial cable is typically comprised of an inner conductor 10, which is usually a solid or bundled strand copper wire, an insulating layer 12 such as a dielectric, a conducting layer 14 typically a braided shield or wound foil, and an outer jacket or sheath 16. The insulating layer 12 provides physical support to the cable and can contribute to the cable being flexible or rigid. Perhaps more importantly, the insulating layer 12 also serves to electrically isolate the inner conductor 10 and the conducting layer 14. This type of coaxial cable is typically used as a transmission line for radio frequency signals, which are low power signals. The structure of the coaxial cable is efficient for such low power signals because the signal being carried exists in the space between the inner conductor 10 and the conducting layer 14. This allows the cable to be placed next to metal materials without significant electromagnetic interference. Unfortunately, the structure of the current common coaxial cable is not well suited for high power transmission. An example of such high power transmission is three phase electric power.

In a three phase electric system, three conductors carry three alternating currents that reach their peak values at different times, the delay between each being one-third of a cycle of the electric current. The high frequency switching typical of AC inverters produces electromagnetic noise due to current fluctuations. The emission of this electromagnetic noise is undesirable because it may interfere with surrounding electronic devices. The current may also produce magnetic fields deemed unacceptable for close human proximity. This is extremely disadvantageous for applications in which electronics requiring high power are present but that packaging constraints result in the wiring being close in proximity to other devices that will be adversely affected by electromagnetic noise.

One such example of such an application is in hybrid vehicles. Hybrid vehicles contain high power electronics, but constraints on the vehicle design limit the distance in which periphery electronic components can be spaced from high power devices and cables. Other cables designed for high power electric transmission exist, but such other cables simply utilize an expensive shielding surrounding the entire cable to reduce electromagnetic emission. The prohibitive cost of the shielding makes such cables undesirable, however. Accordingly, there is a need in the art for a cost-effective solution capable of transmitting high power electric signals with reduced electromagnetic emission such that interference with other electronics is minimized.

### SUMMARY

Accordingly, the present disclosure relates to a coaxial cable capable of transmitting high load electrical power in an electric vehicle, such as three phase electrical power, or a single phase high voltage DC, while minimizing the amount of electromagnetic noise emitted from the cable. The coaxial cable consists of at least two conducting layers with each conducting layer surrounded by an insulation layer. Additionally the disclosure relates to a coaxial cable with two conducting layers used for DC power transmission.

Also provided is a cable for three phase high power electrical transmission for use in an electric vehicle. The cable includes a first conductor, a plurality of second conductors, and a plurality of third conductors. The first conductor has a first electrical phase and is at least partially encased by a first insulating layer. The plurality of second conductors has a second electrical phase and the plurality of third conductors has a third electrical phase. The plurality of second conductors and the plurality of third conductors are radially disposed within the first insulating layer in an alternating arrangement with respect to one another such that the plurality of second conductors and the plurality of third conductors encircle the first conductor, thereby minimizing electromagnetic noise and electromagnetic fields.

Also provided is a cable for high power electrical transmission for use in an electric vehicle. The cable including a first conductor at least partially encased by a first insulating layer, a second conductor at least partially encased by a second insulating layer, and a third conductor at least partially encased by a third insulating layer. The first conductor, the second conductor, and the third conductor are encased by an outer shielding cover. The cable may further include a fourth conductor at least partially encased by a fourth insulating layer. The first conductor and the third conductor transmit single phase DC current in a first direction and the second conductor and the fourth conductor transmit single phase DC current in a second direction. The third conductor and the fourth conductor are disposed in a substantially rectangular arrangement such that the first conductor and the third conductor are diagonal from one another and the second conductor and the fourth conductor are diagonal from one another, thereby minimizing electromagnetic noise and electromagnetic fields.

One advantage of the disclosed cable is that the minimization of the amount of electromagnetic noise emitted from the cable enables the cable to be utilized to transmit high power electric even while in close proximity to other electronic devices, without adversely affecting such other electronic devices, reducing or eliminating the need for shielding. Additionally, the disclosed cable minimizes the magnetic field emissions, which are harmful to humans, allowing for the cables to be routed closer to the passenger cabin with little to no shielding.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of an electric vehicle, according to an exemplary embodiment.

FIG. 2 is a partial cut-away plan view of a high power coaxial cable, according to an exemplary embodiment.

FIG. 3 is a cross-sectional plan view of another exemplary embodiment of a high power coaxial cable.

FIG. 4 is a cross-sectional plan view of still another exemplary embodiment of a high power coaxial cable.

FIG. 5 is a cross-sectional plan view a further exemplary embodiment of a high power cable.

FIG. 6 is a cross-sectional plan view of still further exemplary embodiment of a high power cable.

FIG. 7 is a partial cut-away perspective view of a prior art coaxial cable.

### DESCRIPTION

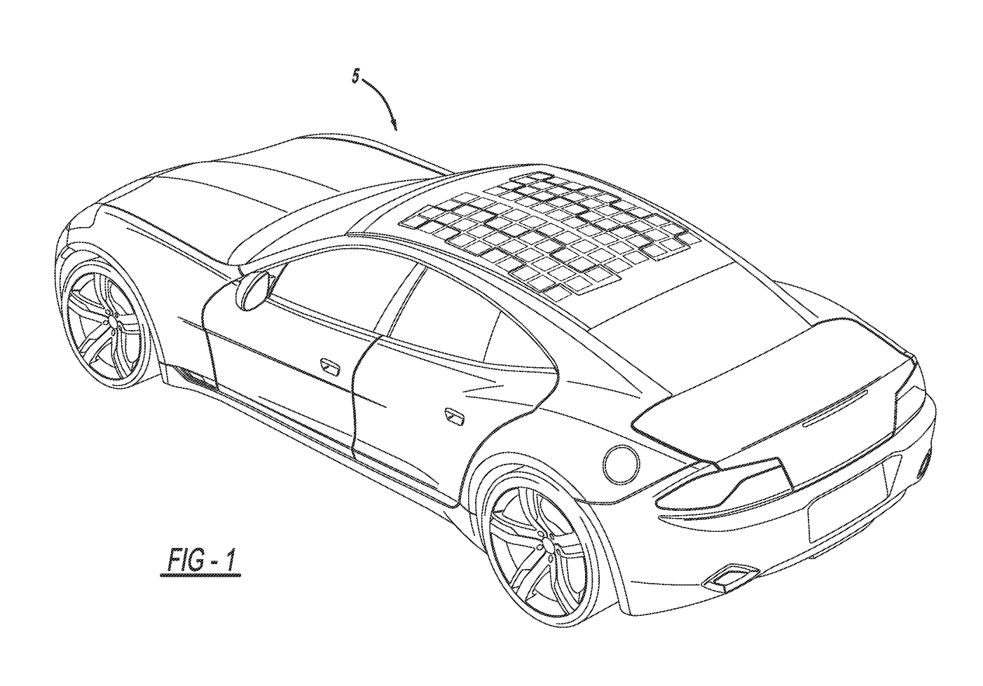

Referring FIG. 1, an electric vehicle 5 is illustrated. In this example, the vehicle 5 is a hybrid electric vehicle (HEV) that is gasoline and electric powered. The vehicle 5 may be a passenger car, truck, or other type of vehicle. The vehicle 5 can also be a full electric vehicle (FEV), a plug-in hybrid electric vehicle (PHEV), or the like. The vehicle 5 also includes an assortment of vehicle components, such as, a powertrain, a drivetrain, an internal combustion engine, electric motors, electric wheel motors, batteries, vehicle control modules, periphery electronic components, or the like.

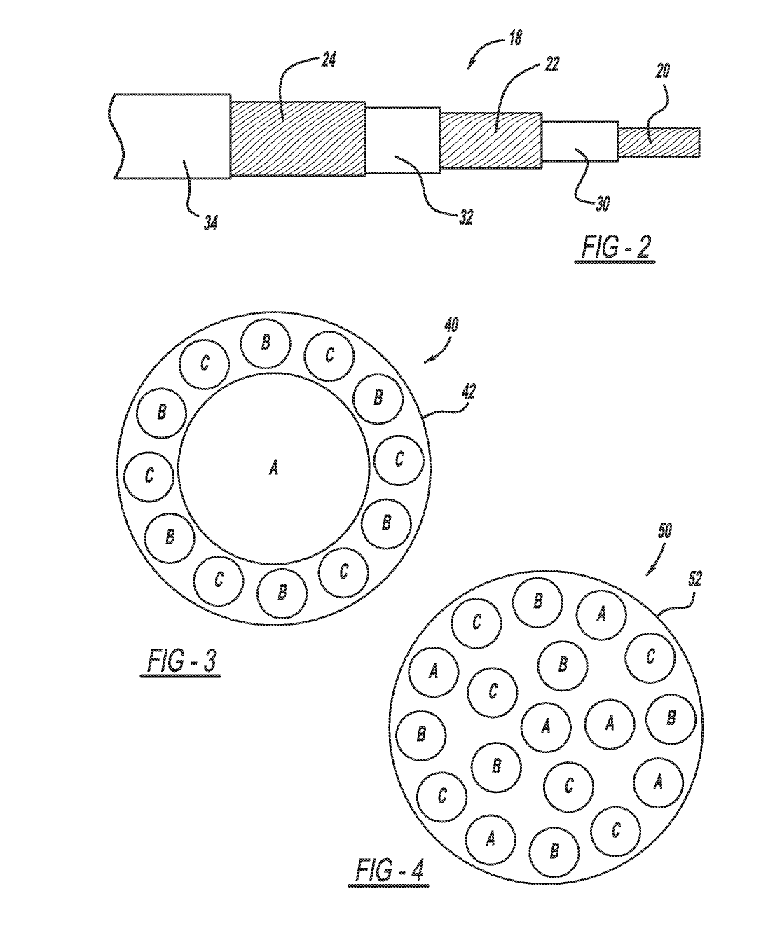

Referring to the FIG. 2, a coaxial cable for transmission of high power electrical power is shown generally at 18. Specifically, the coaxial cable 18 of FIG. 2 is designed for the transmission of three phase electrical power as illustrated by the three conductors 20, 22, and 24. Each of the three conductors 20, 22, and 24 is surrounded by an insulating layer 30, 32, and 34 respectively. Each of the three conductors 20, 22, and 24 are comprised of a conducting material such as a metal or alloy or any other conducting material utilized in the art. Each of the three insulating layers 30, 32, and 34 is either a coating or layer, solid or partial, which is comprised of an electric insulator/dielectric material as used in the art. Examples of such insulator materials include solid plastic, foam plastic, polyethylene, Teflon, or the like. It is also noted that this embodiment can be also be constructed with only two conducting layers for use with DC power transmission.

The first conductor 20 is preferably the innermost portion, or core, of the cable 18. The first conductor 20 may be a single solid wire or multiple stranded wires that are twisted, braided, or otherwise arranged. The first conductor 20 is surrounded by a first insulating layer 30. A second conducting layer 22 surrounds, either completely or partially, the first insulating layer 30. The second conducting layer 22 may be any type of conducting material such as a foil wrap, a braided sheath, a flexible tube, or the like. The second conducting layer 22 is surrounded, either partially or completely, by the second insulating layer 32. The third conducting layer 24 surrounds, either completely or partially, the second insulating layer 32. Similar to the second conducting layer 22, the third conducting layer 24 may be any type of conducting material such as a foil wrap, a braided sheath, a flexible tube, or the like. Similar to both the first insulating layer 30 and the second insulating layer 32, the third insulating layer 34 surrounds the third conducting layer 24. A jacket covering (not shown) or other type of shield may be utilized to surround and effectively enclose the conducting layers 20, 22, and 24 and the insulating layers 30, 32, and 34.

Referring now to FIGS. 3 and 4, another exemplary embodiment of a three phase cable is illustrated in which the various phases are dispersed throughout the cable. The cable 40 of FIG. 3 utilizes a first conductor, relating to a first electric phase, marked as ‘A’ in the center. The other two conductors, relating to the second and third phases and marked as ‘B’ and ‘C’ are split and spaced around the first conductor A. Conductors B and C encircle conductor A in a uniform and alternating manner such that no conductor (B, C) is directly adjacent the same type of conductor (B, C). An insulating layer 42 surrounds conductor A and contains the B and C conductors. The cable 50 of FIG. 4 disperses all three conductors (phases) A, B, and C throughout an insulating layer 52. The various conductors (A, B, C) can also be spaced apart at a predetermined distance and uniformly distributed across the cross-section of the insulating layer 52. The pattern of the conductors as shown in FIGS. 3 and 4 are for exemplary purposes only and one skilled in the art will appreciate that the “pattern” may be altered from those shown in FIGS. 3 and 4 without straying from the scope of the present disclosure.

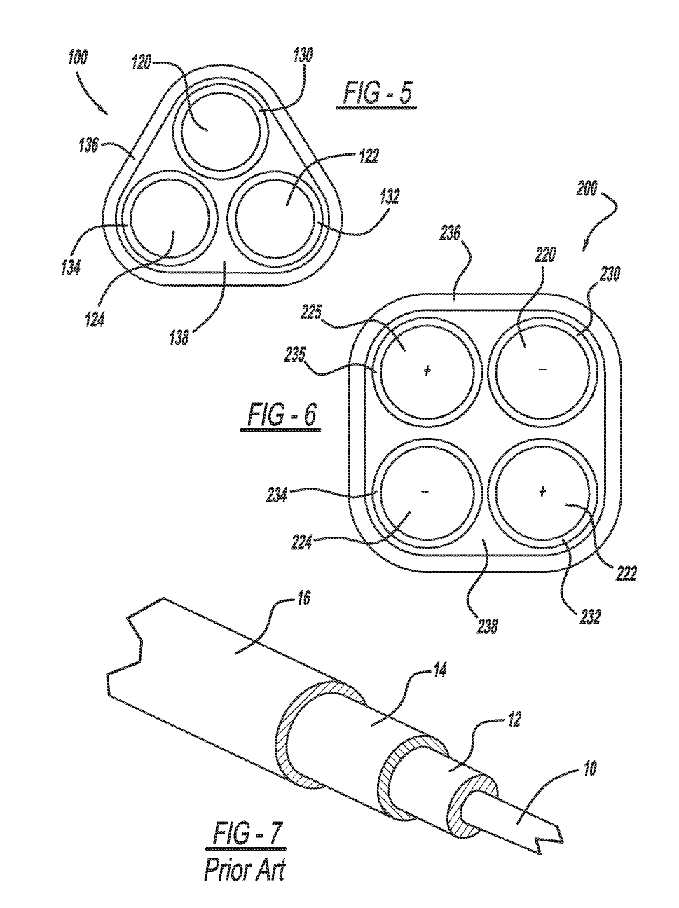

Referring now to FIG. 5, a further exemplary embodiment of a high power cable 100 is shown. In this embodiment, the high power coaxial cable 100 is designed for the transmission of three phase electrical power as illustrated by the three conductors 120, 122, and 124. Each of the three conductors 120, 122, and 124 is surrounded by an insulating layer 130, 132, and 134 respectively. Each of the three conductors 120, 122, and 124 are comprised of a conducting material such as a metal or alloy or any other conducting material utilized in the art. Each of the three insulating layers 130, 132, and 134 is either a coating or layer, solid or partial, which is comprised of an electric insulator/dielectric material as used in the art. Examples of such insulator materials include solid plastic, foam plastic, polyethylene, Teflon, or the like. Each of the conductors 120, 122, 124 may be a single solid wire or multiple stranded wires that are twisted, braided, or otherwise arranged. The high power cable 100 also includes a jacket covering or layer or shielding 136 or other type of shield to surround and effectively enclose the conducting layers 120, 122, and 124 and the insulating layers 130, 132, and 134. The high power cable 100 can also include additional insulation material within the jacket cover 136, the insulating layers 130, 132, 134, and/or the inner space 138 between individual conductors within the cable 100. The cable 100 can also include shielding in the cover 136, such that all three conductions 120, 122, 124 are shielded by the same shield. The conductors 120, 122, 124 can be arranged within the inner space of the cable in a variety of manners, such as, a generally triangular formation as shown, or the like. The conductors 120, 122, 124 can also be spaced apart from one another at a varying distances depending vehicle requirements.

Referring now to FIG. 6, a further exemplary embodiment of a high power cable 200 is shown. In this embodiment, the high power cable 200 is similar to the cable 100 shown in FIG. 5 but is designed for the transmission of single phase DC electrical power as illustrated by the four conductors 220, 222, 224, and 225. Each of the four conductors 220, 222, 224, and 225 is surrounded by an insulating layer 230, 232, 234, and 235 respectively. Each of the four conductors 220, 222, 224, and 225 are comprised of a conducting material such as a metal or alloy or any other conducting material utilized in the art. Each of the three insulating layers 230, 232, 234, and 235 is either a coating or layer, solid or partial, which is comprised of an electric insulator/dielectric material as used in the art. Examples of such insulator materials include solid plastic, foam plastic, polyethylene, Teflon, or the like. Each of the conductors 220, 222, 224, 225 may be a single solid wire or multiple stranded wires that are twisted, braided, or otherwise arranged. The high power cable 200 also includes a jacket covering or layer or shielding 236 or other type of shield to surround and effectively enclose the conducting layers 220, 222, 224 and 225 and the insulating layers 230, 232, 234, and 235. The high power cable 200 can also include additional insulation material within the jacket cover 236, the insulating layers 230, 232, 234, 235, and/or the inner space 238 between conductors within the cable 200. The high power cable 200 can also include shielding material within the jacket cover 236, so that all four cables are shielded by one shield. The conductors 220, 222, 224, 225 can be arranged within the inner space of the cable in a variety of manners, such as, a generally rectangular formation as shown, or the like. The conductors 220, 222, 224, 225 can also be spaced apart from one another at a varying distances depending vehicle requirements. The conductors 220, 222, 224, 225 are also arranged such that current in the upper left and lower right portions or corners of the coaxial cable 200 flows in a first direction (marked as “+”) and the upper right and lower left portions or corners of the cable 200 flows in a second or opposite direction (marked as “−”).

One skilled in the art will appreciate that this written description and accompanying drawings are for exemplary purposes and that many modifications are possible. For example an outer jacket or sheath could enclose the inside components of the cable. Additionally, the types of materials utilized and the particular sizes and thicknesses of materials used may be modified to adhere to particular standards, regulations, or other requirements in view of the intended application and/or use. Also, while a three phase cable is disclosed, one skilled in the art will appreciate that the teachings may be applied to any multiphase cable, including one with only two conductors or more than three conductors.

It should also be noted that the cable described in the present disclosure can be used in a variety of manners and coupled to a variety of different vehicle components. For example, the cable can be coupled at one end to a vehicle battery (or inverter which converts DC power to three-phase power) and coupled at another end to a vehicle motor to transmit three phase AC power to the motor. Moreover, while the cable of the present disclosure has been described in the context of an electric vehicle, the cable can be adapted to be used in various other vehicles, industrial equipment, high-frequency power electronics, such as, transformers, power converters, or the like.

Many modifications and variations of the present disclosure are possible in light of the above teachings. Therefore, within the scope of the appended claim, the present disclosure may be practiced other than as specifically described.

What is claimed is:

1. A coaxial cable for high power electrical transmission for use in an electric vehicle, the coaxial cable comprising:
a first conducting layer at least partially encased by a first insulating layer;
a second conducting layer at least partially encased by a second insulating layer, wherein the second conducting layer at least partially encases the first insulating layer; and
a third conducting layer at least partially encased by a third insulating layer, wherein the third conducting layer at least partially encases the second insulating layer, such that the first conducting layer, the first insulating layer, the second conducting layer, the second insulating layer, the third conducting layer, and the third insulating layer are concentrically disposed within one another respectively.

2. The coaxial cable of claim 1, further comprising an outer shielding cover to at least partially enclose the first, second, and third conducting layers, and the first, second, and third insulating layers.

3. The coaxial cable of claim 1, wherein the first conducting layer is one of a solid wire and multiple stranded wires.

4. The coaxial cable of claim 1, wherein the second conducting layer and the third conducting layer are one of a foil wrap, a braided sheath, and a flexible tube.

5. The coaxial cable of claim 1, wherein the first and second conducting layers are made from one of a metal and an alloy.

6. The coaxial cable of claim 1, wherein the first and second insulating layers are made from one of dielectric material including one of plastic, foam plastic, polyethylene, and Teflon.

7. The coaxial cable of claim 1, wherein the coaxial cable transmits high load electrical power including one of three phase electrical power and single phase high voltage DC.

8. A cable for three phase high power electrical transmission for use in an electric vehicle, the cable comprising:
a first conductor having a first electrical phase, the first conductor at least partially encased by a first insulating layer;
a plurality of second conductors having a second electrical phase;
a plurality of third conductors having a third electrical phase; and
wherein the plurality of second conductors and the plurality of third conductors are disposed within the first insulating layer.

9. The cable of claim 8, wherein the plurality of second conductors and the plurality of third conductors are radially disposed within the first insulating layer in an alternating arrangement with respect to one another such that the plurality of second conductors and the plurality of third conductors encircle the first conductor, thereby minimizing electromagnetic noise and electromagnetic fields.

10. The cable of claim 8, wherein the first conductor has a larger diameter than the second conductor and the third conductor.

11. The cable of claim 8, further comprising a plurality of first conductors having a first electrical phase.

12. The cable of claim 11, wherein the plurality of first conductors, the plurality of second conductors, and the plurality of third conductors are disposed uniformly within the first insulating layer.

13. A cable for high power electrical transmission for use in an electric vehicle, the cable comprising,
a first conductor at least partially encased by a first insulating layer;
a second conductor at least partially encased by a second insulating layer;
a third conductor at least partially encased by a third insulating layer; and
wherein the first conductor, the second conductor, and the third conductor are encased by an outer shielding cover.

14. The cable of claim 13, further comprising a fourth conductor at least partially encased by a fourth insulating layer.

15. The cable of claim 14, wherein the first conductor and the third conductor transmit single phase DC current in a first direction and the second conductor and the fourth conductor transmit single phase DC current in a second direction.

16. The cable of claim 15, wherein the first conductor, the second conductor, the third conductor and the fourth conductor are disposed in a substantially rectangular arrangement such that the first conductor and the third conductor are diagonal from one another and the second conductor and the fourth conductor are diagonal from one another, thereby minimizing electromagnetic noise and electromagnetic fields.
